(19) United States
(12) Patent Application Publication
(10) Pub. No.: US 2019/0180567 A1
(43) Pub. Date: Jun. 13, 2019

(54) MULTIPLAYER GAMING SYSTEM AND METHOD OF USE

(71) Applicant: John Duong, Richmond, TX (US)

(72) Inventor: John Duong, Richmond, TX (US)

(21) Appl. No.: 16/219,024

(22) Filed: Dec. 13, 2018

Related U.S. Application Data
(60) Provisional application No. 62/598,151, filed on Dec. 13, 2017.

(51) Int. Cl. G07F 17/32

(52) U.S. Cl. CPC G07F 17/3276; G07F 17/3244; G07F 17/3211; G07F 17/3286

(57) ABSTRACT

A multiplayer gaming system includes a gaming cabinet having player stations, the gaming cabinet having a display located in a central region of the gaming cabinet and visible from each of the player stations; the display is to provide visual graphics; each player stations having a joystick to control a simulated weapon; and one or more buttons to provide controls for an associated player; a gaming platform to be implemented through a computing system, the gaming platform to control the display and having a player module associated with each of the player stations to receive commands from each of the player stations, the player module having a bullet point setting to be selected by the associated player; a target locking setting to be activated by the associated player.

### BACKGROUND

### 1. Field of the Invention

The present invention relates generally to game systems, and more specifically, to a multiplayer gaming system for with improved point value collection and use for improved enjoyment and competition associated with the multiplayer gaming system.

### 2. Description of Related Art

Game systems are well known in the art and are effective means to provide recreational activities, gambling activities, and competitive activities. For example, conventional game systems conventionally require the input of a monetary value, allowing for the user to play a game on a screen presented to the user. Many games involve the simulated shooting of targets for the collection of points. One of the problems commonly associated with these conventional target centered games, is the lack of opportunity for the player to increase their point value significantly with each shot. Such a feature would provide for increased competition and enjoyment associated with the game.

Accordingly, although great strides have been made in the area of game systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified top view of a multiplayer game system in accordance with a preferred embodiment of the present application;

FIG. 2 is a simplified side view of the game cabinet from FIG. 1;

FIG. 3 is a simplified schematic of features associated with a player station of FIG. 1;

FIG. 4 is a simplified schematic of the features of a game module from FIG. 1 to be implemented through a computer system; and

FIG. 5 is a flowchart of the method of use of the system of FIG. 1.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional game systems. Specifically, the present invention provides an improved game system with improved point awarding and collection system. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

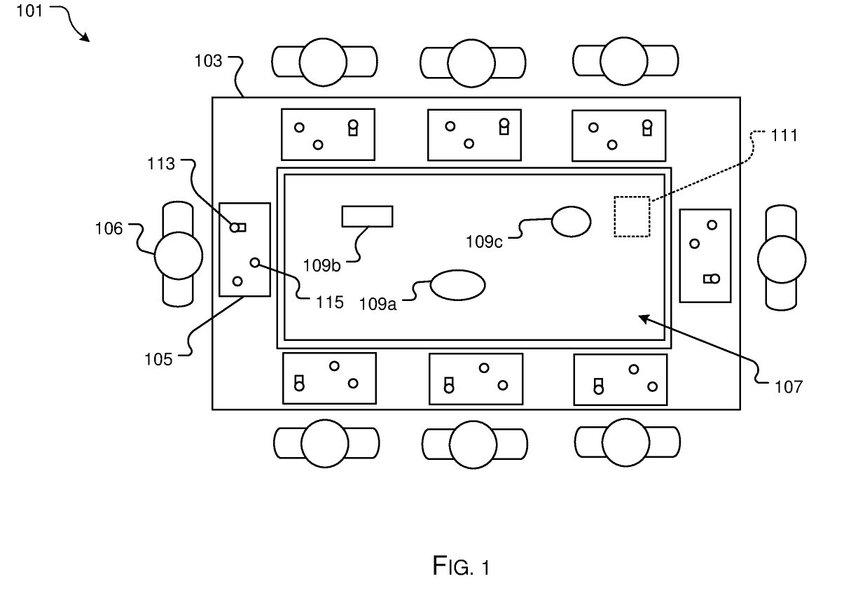

Referring now to the drawings wherein like reference characters identify corresponding or similar elements throughout the several views, FIG. 1 depicts a simplified top view of a multiplayer game system 101 in accordance with a preferred embodiment of the present application. It will be appreciated that system 101 overcomes one or more of the above-listed problems commonly associated with conventional game systems.

In the contemplated embodiment, system 101 includes a gaming cabinet 103 having a plurality of player stations 105 and a display 107 positioned in a central region of the cabinet and visible from each of the player stations 105 for each player 106. It should be appreciated that the size of cabinet 103 can vary, in addition, it should be appreciated that the overall aesthetical appearance and number of player stations can vary as desired. It should further be appreciated that the cabinet 103 can include the necessary components to create a digital display, including LED lights, a power source, a plurality of speakers, and a control system.

Display 107 is configured to provide a graphical display of a plurality of game components, including at least a plurality of targets 109a-c. Said targets 109 can vary in colors, styles, types, sizes, and other visual components. It should be appreciated that the interaction between the plurality of player stations and display 107 is controlled via a game module 111 implemented through a computing system, including the necessary components such as a processor, an algorithm, and any other necessary elements.

Each of the plurality of player stations 105 include control components, including a joystick 113 and one or more buttons 115, the joystick 113 and one or more buttons controlling a simulated weapon (not shown), the simulated weapon being control to shoot one or more of the plurality of targets, as will be described in detail herein.

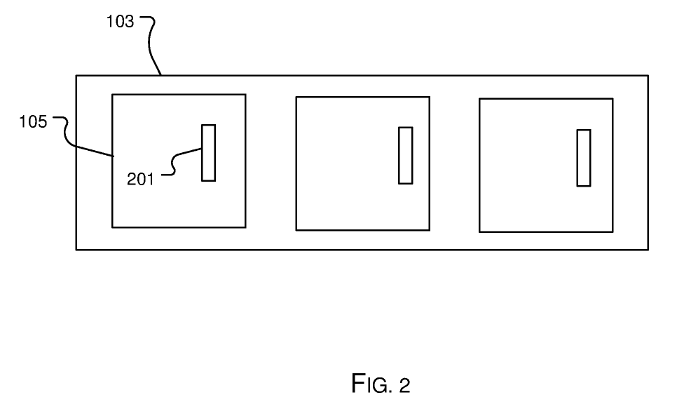

In FIG. 2, a simplified side view of cabinet 103 shows the potential inclusion of a plurality of payment devices 201 associated with each of the plurality of player stations 105, thereby being configured to collect a currency from each user to activate use of the player station.

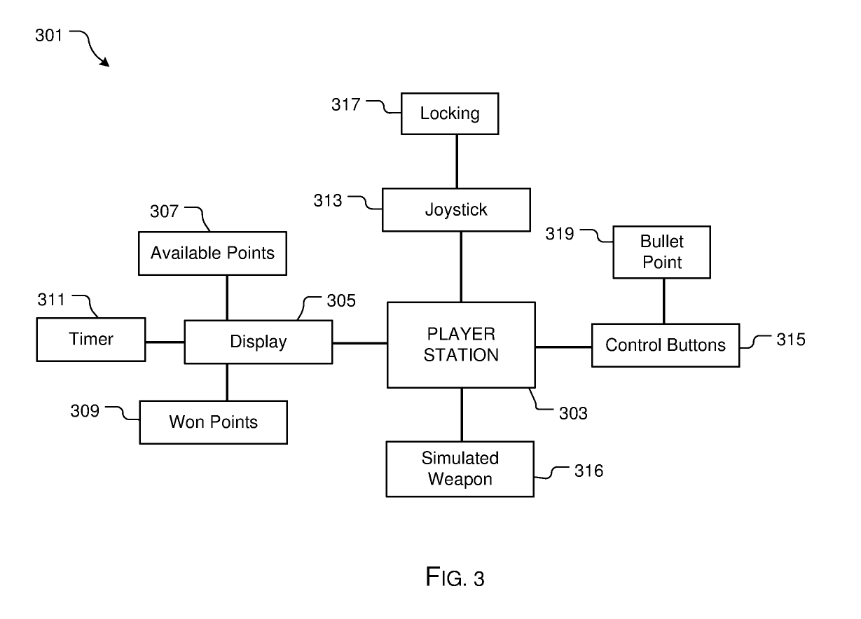

In FIG. 3, a simplified schematic 301 demonstrates the features associated with each of the plurality of player stations 303. Each player station 303 includes a display 305, such as digital display to be presented to the associated player. The display can include various visual representation of the status of an ongoing game, including available points 307, won points 309, and a game timer 311. In one embodiment, the available points 307 are presented to the associated player for selection during the game, wherein the selection of a portion of the available points places the points at risk during firing of the simulated weapon. It should be appreciated that the won points 309 can be retained and tracked completely separately from the available points, thereby being available for redemption or ranking at the end of the game session.

Each player station 303 is further associated with a joystick 313 and one or more control buttons 315. In the preferred embodiment joystick 313 provides a means for the associated player to both move the simulated weapon 316 for aiming, and further provides a means for the user select a activate a target locking setting 317, the target locking setting which allows the associated player to target certain targets within the display of the gaming system. In one embodiment, this feature is achieved via tapping the joystick down twice to activate the locking setting. In the preferred embodiment, one or more of the control buttons 315 is associated with a means to increase a bullet point value 319, which allows the associated player to risk more points when firing at a target.

As an example, the associated user can increase the bullet point value from one to ten via the one or more buttons. The associated user can further activate the target locking mechanism. The user then proceeds to fire the simulated weapon at the target, risking the ten points. If the associated player hits the target, the user's won points 309 increases by ten times the number of points associated with the hit target. If the associated player misses the target, the user's available points 307 will drop by ten. It must be understood that this example is one example, and the numbers and values discussed herein can be altered drastically.

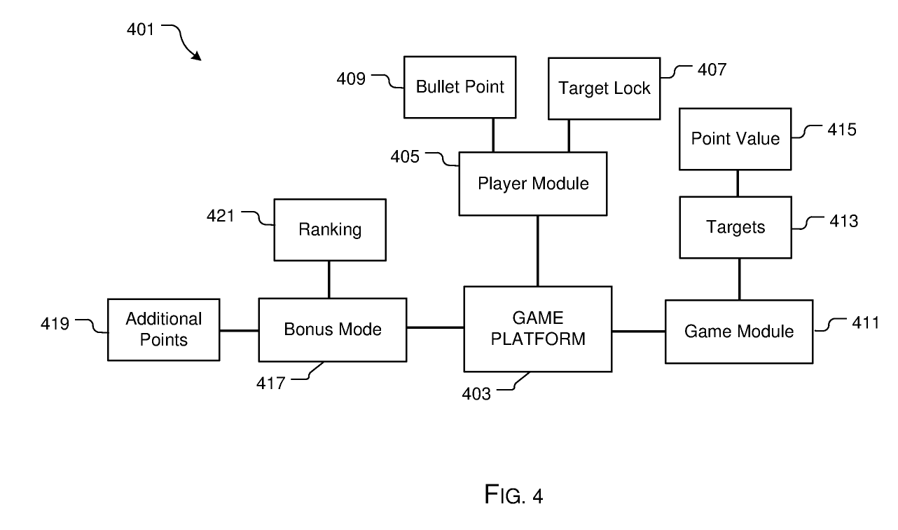

In FIG. 4, a simplified schematic 401 of a game platform 403 to be implemented through the computing system and into the display is shown. Game platform 403 includes a player module 405 associated with each of the plurality of player stations. The player module 405 provides the software and processing needed to allow the associated player to activate the target lock 407 and alter the bullet point value 409. Game platform further includes a game module 411 associated with the visual display of an ongoing game and the interaction between the plurality of player stations and the display. Game module 411 is in control of the plurality of targets 413, each of the plurality of targets having a designated point value 415.

In one contemplated embodiment, game platform 403 further includes a bonus mode 417 module configured to be activated upon a pre-determined criteria, such as a time frame, an input from a computing system, or other criteria. In this embodiment, bonus mode module is activated for a predetermined time, such as 6 minutes, wherein all associated players that are active, such as actively shooting, have the opportunity to earn additional point values 419 to be added to their “won points”. It should be appreciated that the additional point values 419 can be based on a ranking 421 of the active players, such as a 1^{st}, 2^{nd} and 3^{rd}.

It should be appreciated that one of the unique features believed characteristic of the present application is the separation of won points and available points, thereby allowing for each of the plurality of players to track won points. Another unique feature believed characteristic of the present application is the bonus mode, allowing for each of the players to significantly increase their point values.

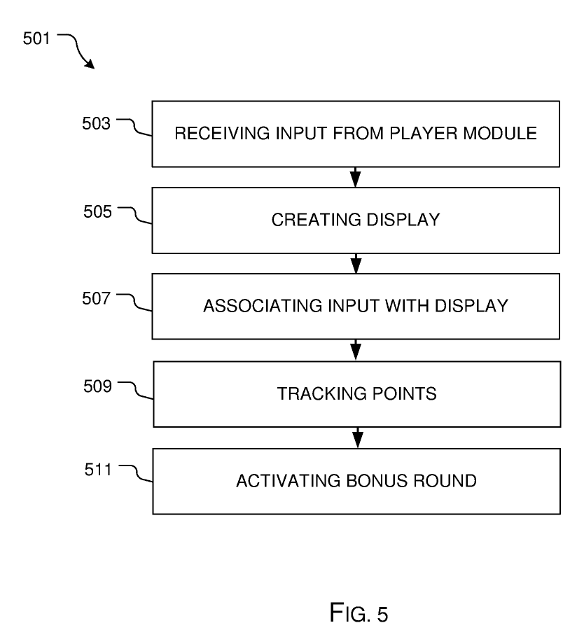

In FIG. 5, a flowchart 501 depicts the method of use associated with game system 101. During use, the plurality of players control the player module through the plurality of player stations, thereby sending input and command into the game platform, as shown with box 503. The display associated with the game is created based on pre-determined settings and input from the plurality of players, as shown with boxes 505, 507. As the game progresses, the points associated with each player are tracked, which can be kept as won points or as available points, as shown with box 509. Upon a predetermined criteria, the bonus round is activated for active players, wherein each of the plurality of players can earn additional points and can be ranked based on their point values, as shown with box 511.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A multiplayer gaming system, comprising:
a gaming cabinet having a plurality of player stations, the gaming cabinet having:
a display located in a central region of the gaming cabinet and visible from each of the plurality of player stations;
wherein the display is configured to provide visual graphics;
each of the plurality of player stations having:
a joystick configured to control a simulated weapon; and
one or more buttons configured to provide controls for an associated player;
a gaming platform configured to be implemented through a computing system, the gaming platform to control the display, the gaming platform having:
a player module associated with each of the plurality of player stations and configured to receive commands from each of the plurality of player stations, the player module having:
a bullet point setting to be selected by the associated player;
a target locking setting to be activated by the associated player; and
a points display configured to provide the associated player with a number of points available for use in the multiplayer gaming system;
a game module configured to be implemented through the computing system and onto the display, the game module providing a plurality of targets to be pursued via the target locking setting of the player module, each of the plurality of targets having an associated point value;
wherein a selection of a bullet point value by the associated player is multiplied by the associated point value of one of the plurality of targets pursued by the player, to create a point number, when the associated player hits the one of the plurality of targets with the simulated weapon, thereby adding the point number to the points display.

2. The system of claim 1, wherein the points display further comprises:
a first point value associated with a first number of points deemed available; and
a second point value associated with a second number of points deemed won.

3. The system of claim 1, wherein the gaming cabinet further comprises:
a plurality of payment device associated with the plurality of player stations and configured to receive a currency from each player.

4. The system of claim 1, wherein the gaming platform further comprises:
a bonus mode configured to activate upon a command from the computing system, the bonus mode configured to determine which of a plurality of players are actively involved in the multiplayer gaming system and generate a ranking of the plurality of players.

5. The system of claim 4, wherein the bonus mode is configured to automatically add a plurality of points to each of the plurality of players based on the ranking.

6. A gaming system to be implemented on a gaming cabinet, the gaming system comprising:
a computing system configured to process commands to create a display on the gaming cabinet;
a gaming platform comprising:
a player module associated with each of a plurality of player stations of the gaming cabinet and configured to receive commands from each of the plurality of player stations, the player module having:
a bullet point setting to be selected by an associated player;
a target selection setting to be selected by the associated player; and
a points display configured to provide the associated player with a number of points available for use in gaming platform;
a game module configured to be implemented through the computing system and into the gaming cabinet, the game module providing a plurality of targets to be pursued via the target selection setting of the player module, each of the plurality of targets having an associated point value;
wherein a selection of a bullet point value by the associated player is multiplied by the associated point value of one of the plurality of targets pursued by the player, to create a point number, when the associated player hits the one of the plurality of targets with the simulated weapon, thereby adding the point number to the points display.

7. The system of claim 6, wherein the points display further comprises:
a first point value associated with a first number of points deemed available; and
a second point value associated with a second number of points deemed won.

8. The system of claim 6, wherein the gaming platform further comprises:
a bonus mode configured to activate upon a command from the computing system, the bonus mode configured to determine which of a plurality of players are actively involved in the multiplayer gaming system and generate a ranking of the plurality of players.

9. The system of claim 8, wherein the bonus mode is configured to automatically add a plurality of points to each of the plurality of players based on the ranking.

10. A method of providing a gaming interaction between a plurality of players, the method comprising:
providing the system of claim 1;
receiving input from the player module associated with each of the plurality of players, the input relating to the bullet point setting and the target selection;
creating the display with a plurality of visual graphics;
associating the input from the player module to the display; and
receiving one or more commands from the plurality of player stations, the one or more commands generated from one or more of the joystick and the one or more buttons.

11. The method of claim 10, further comprising:
collecting point values based on the or more commands causing an association between the associated player and a target.

12. The method of claim 11, wherein the point values are separated into available points and won points.

13. The method of claim 10, further comprising:
activating a bonus round for a selection of the plurality of players, the selection based on whether each of the plurality of players is active; and
generating additional points for each of the plurality of players based on a ranking of the plurality of players.
